(19) United States
(12) Patent Application Publication
(10) Pub. No.: US 2021/0069753 A1
(43) Pub. Date: Mar. 11, 2021

(54) SCRAPER-BASED MAGNETIC CLEANING SYSTEM AND METHOD FOR CLEANING FERROMAGNETIC OBJECTS

(71) Applicant: The Boeing Company, Chicago, IL (US)

(72) Inventors: Daniel M. Rotter, Lake Forest Park, WA (US); Brad A. Coxon, Everett, WA (US); Kin Ung, Lynnwood, WA (US); Christopher Vernon Grubbs, Everett, WA (US); James Isaac Hart, III, Edmonds, WA (US); Johnny Hong, Renton, WA (US)

(21) Appl. No.: 16/566,650

(22) Filed: Sep. 10, 2019

(51) Int. Cl. B08B 1/00; B08B 7/00

(52) U.S. Cl. CPC B08B 1/005; B08B 7/00

(57) ABSTRACT

A cleaning system and a method for cleaning a surface of a ferromagnetic object are disclosed. Accordingly, to an example configuration, the cleaning system includes a device body having a guide face configured for selective placement against the surface. The device body comprises a magnetic system generating a magnetic field configured to urge the guide face against the surface of the ferromagnetic object by a magnetic force. The cleaning system further includes a scraper blade projecting outward from the device body to contact the surface upon placement of the guide face against the surface. The guide face may optionally comprise an outward-facing abrasive surface.

### CROSS REFERENCE TO RELATED APPLICATIONS

This application incorporates herein by reference for all purposes the entire contents of U.S. patent application Ser. No. 16/566,219 filed Sep. 10, 2019, titled “MAGNETIC CLEANING SYSTEM AND METHOD FOR CLEANING FERROMAGNETIC OBJECTS”, and assigned docket number 19-0177-US-NP.

### FIELD

The invention relates generally to cleaning a surface of a ferromagnetic object with a scraper blade that is urged against the surface of the ferromagnetic object by a magnetic force.

### BACKGROUND

Composite materials may be formed during layup operations using cure tooling that incorporate ferromagnetic materials, such as Invar—a nickel-iron alloy relied upon for its low coefficient of thermal expansion. Contaminants including tape residue from vacuum bagging, resin, ferromagnetic dust, and other contaminants may build up on cure tooling from use, which may require periodic cleaning of cure tooling surfaces. Aeronautical components formed of composite materials including wing spars, stringers, skin panels, etc. may use cure tooling of relatively large dimensions and/or complex geometry that may pose challenges for manufacturing personnel to consistently and adequately clean between layup operations.

### SUMMARY

According to an example of the present disclosure, a cleaning system for cleaning a surface of a ferromagnetic object includes a device body having a guide face configured for selective placement against the surface. The device body comprises a magnetic system generating a magnetic field configured to urge the guide face against the surface of the ferromagnetic object by a magnetic force. The cleaning system further includes a scraper blade projecting outward from the device body to contact the surface upon placement of the guide face against the surface. The guide face may optionally comprise an outward-facing abrasive surface.

The example features and techniques discussed in the Summary can be provided independently in various embodiments or may be combined in yet other embodiments, further details of which are described by the following description and drawings.

### BRIEF DESCRIPTION OF THE DRAWINGS

FIG. 1 depicts an example of a cleaning system for cleaning a surface of a ferromagnetic object.

FIG. 2 depicts the scraper blade of FIG. 1 projecting outward from the device body at an example orientation.

FIG. 3 depicts an example configuration of the cleaning system of FIG. 1 in which a leading edge of the scraper blade is orthogonal to a long axis of the device body.

FIG. 4 depict another example configuration of the cleaning system of FIG. 1 in which a leading edge of the scraper blade is angled relative to a long axis of the device body.

FIG. 5 depicts example configurations of the magnetic system of FIG. 1.

FIG. 6 depicts an example configuration of the magnetic system of FIG. 1, including electromagnets.

FIGS. 7A-7C depict example magnet configurations in relation to an example guide face of the cleaning system of FIG. 1.

FIGS. 8A-8G depict example features that may be used with cleaning system of FIG. 1.

FIGS. 9A-9C depict example device body configurations that provide a non-planar guide face.

FIGS. 10A and 10B depict an example configuration of the device body of the cleaning system of FIG. 1, including a non-abrasive guide portion.

FIGS. 11A and 11B depict example configurations for moving the cleaning system of FIG. 1.

FIG. 12 is a flow diagram depicting an example method for cleaning a surface of a ferromagnetic object.

FIGS. 13 and 14 depict example abrasive layers that are permeable by ferromagnetic particulate or contaminant particulate produced by cleaning a surface of a ferromagnetic object.

### DETAILED DESCRIPTION

A scraper-based cleaning system and a method for cleaning a surface of a ferromagnetic object are disclosed. According to an example configuration, the cleaning system includes a device body having a guide face configured for selective placement against the surface. The device body comprises a magnetic system generating a magnetic field configured to urge the guide face against the surface of the ferromagnetic object by a magnetic force. The cleaning system further includes a scraper blade projecting outward from the device body to contact the surface upon placement of the guide face against the surface. The guide face may optionally comprise an outward-facing abrasive surface.

The device body of the cleaning system may be manipulated by hand or by machine to remove contaminants from a surface of a ferromagnetic object via the scraper blade and/or via the outward-facing abrasive surface of the guide face. By placing the guide face against the surface to be cleaned, the guide face assists in maintaining a target angle of the scraper blade in relation to the surface during a cleaning operation. The magnetic force that urges the guide face against the surface of the ferromagnetic object also assists in maintaining contact between the guide face and the surface during the cleaning operation. Therefore, the magnetic force generated by the magnetic system assists in maintaining the target angle of the scraper blade during a cleaning operation through improved contact between the guide face and the surface.

The magnetic force that urges the guide face against the surface during a cleaning operation may also provide a more consistent force with less user fatigue as compared to hand-operated cleaning tools that rely exclusively on user-applied forces, particularly for cleaning cure tooling of large and/or complex geometries. Additionally, ferromagnetic particulate generated from ferromagnetic surfaces of ferromagnetic objects during the cleaning operation may be collected by the magnetic system through magnetic attraction, thereby reducing the presence of free ferromagnetic particulate within the manufacturing environment.

A strength of the magnetic field generated by the magnetic system may be selected to achieve a target magnetic force that urges the guard face and the scraper blade against the surface of the ferromagnetic object. In at least some examples, the magnetic field generated by the magnetic system may be adjustable in relation to the guide face and/or the scraper blade to achieve a target magnetic force. The magnetic force generated by the magnetic system may be selected to be of sufficient strength so as to maintain the cleaning system in contact with the surface of the ferromagnetic object, including vertical surfaces, even if the cleaning system is released from a user's hand, thereby reducing injury that could be caused by the scraper blade falling away from the surface of the ferromagnetic object. Through selection or adjustment of the magnetic field strength and the corresponding magnetic force, a target cleaning rate may be achieved by the cleaning system that balances the competing goals of removing tape residue, resin, ferromagnetic dust, and other contaminants from the surface of the ferromagnetic object while also minimizing wear to the surface from the scraper blade and/or the outward-facing abrasive surface.

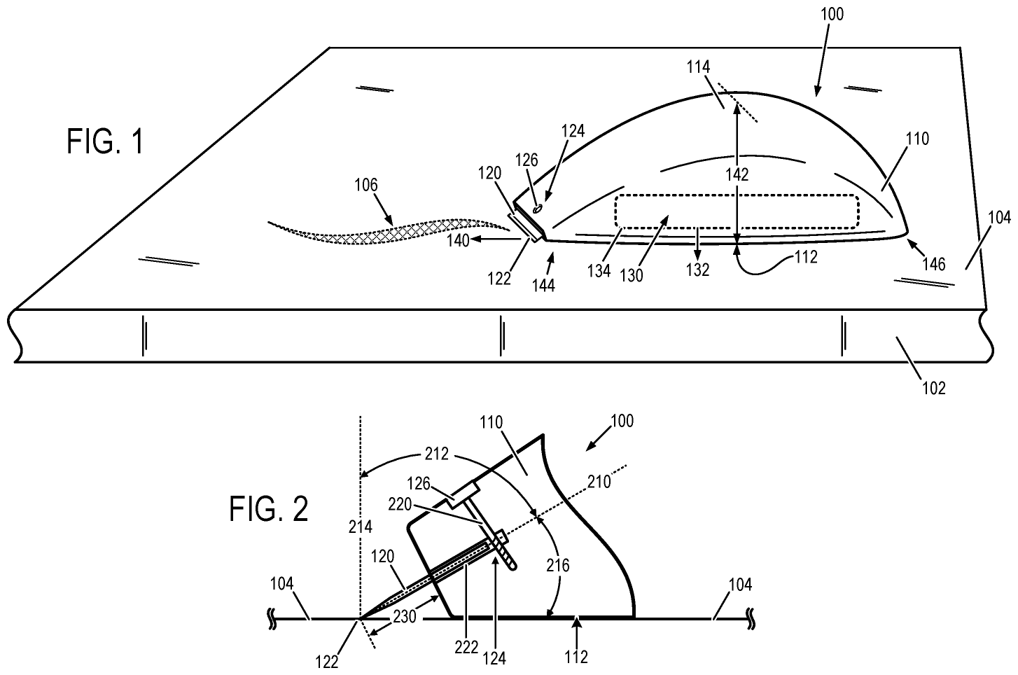

FIG. 1 depicts an example of a cleaning system 100 for cleaning a surface of a ferromagnetic object. Within FIG. 1, an example ferromagnetic object 102 includes a surface 104 having contaminants 106 to be cleaned from the surface by cleaning system 100. As an example, ferromagnetic object 102 may include cure tooling of large and/or complex geometry used in manufacturing of aeronautical components formed of composite materials including wing spars, stringers, skin panels, etc. Within the context of composite layup, for example, contaminants 106 may include tape and tape residue from vacuum bagging operations, resin, ferromagnetic dust, etc.

Cleaning system 100 includes a device body 110 having a guide face 112 configured for selective placement against surface 104 of ferromagnetic object 102. Guide face 112 may optionally comprise a surface-interfacing layer having an outward-facing abrasive surface or an outward-facing reduced-friction surface that engages with surface 104. Device body 110 has an upper surface 114 that opposes guide face 112. Upper surface 114 form a control surface that is ergonomically shaped for a human hand, a handle, or other mechanical interface by which device body 110 may be manipulated. It will be understood that the example configuration of device body 110 of FIG. 1 is provided for illustrative purposes, as the device body may take other suitable forms, examples of which are described in further detail herein.

Cleaning system 100 further includes a scraper blade 120 projecting outward from device body 110 to contact surface 104 at a leading edge 122 upon placement of guide face 112 against the surface. Leading edge 122 of scraper blade 120 points in a direction that has a vector component in a primary cleaning direction 140 of cleaning system 100, thereby enabling the leading edge to come into contact with and remove contaminants 106 when cleaning system 100 is moved in the primary cleaning direction. Example orientations of scraper blade 120 are described in further detail with references FIGS. 2-4.

Scraper blade 120 may be mounted to device body 110 via a scraper blade mount 124 that is configured to retain the scraper blade at a fixed orientation (e.g., angle) relative to guide face 112. Scraper blade mount 124 may be configured to allow a distance that scraper blade 120 projects outward from device body 110 along a fixed orientation to be selectively adjusted. For example, scraper blade mount 124 may include an adjustment interface 126 (e.g., a fastener that provides a clamping force on a portion of the scraper blade) that may be tightened to retain scraper blade 120 at a fixed position relative to the device body, and may be loosened to enable the scraper blade to be drawn out of or inserted into the scraper blade mount. Scraper blade 120 may take the form of a replaceable blade or razor formed of ceramic, metal, plastic, or other suitable material. However, in other examples, scraper blade 120 may be directly integrated with the material of device body 110.

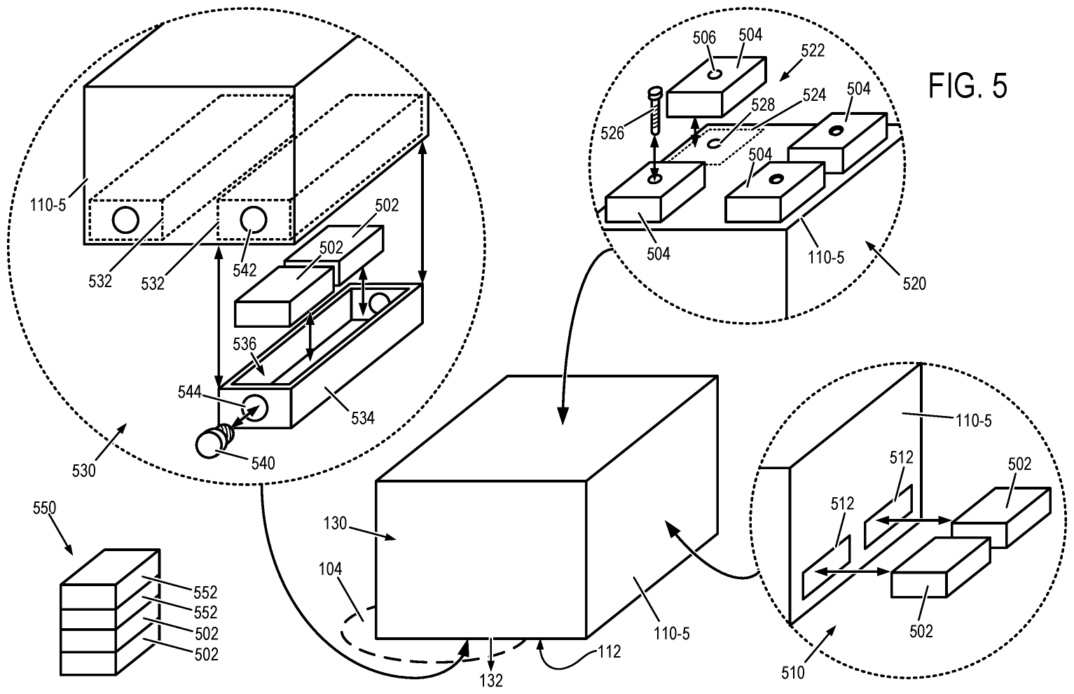

Device body 110 further comprises a magnetic system 130 configured to generate a magnetic field that is configured to urge guide face 112 against surface 104 of ferromagnetic object 102 by a corresponding magnetic force 132. Magnetic system 130 may include one or more magnets, represented schematically at 134. Example configurations of magnetic system 130 are described in further detail with reference to FIGS. 5-9C. Briefly, the one or more magnets 134 of magnetic system 130 may include permanent magnets that generate a persistent magnetic field and/or electromagnets that generate a magnetic field responsive to electrical current being supplied to the electromagnets. In at least some examples, device body 110 may be partially or wholly formed from a permanent magnet material that generates a persistent magnetic field for magnetic system 130.

In further examples, device body 110 may be formed from a non-magnetic and/or non-ferromagnetic material and may define one or more receptacles or mounts that accommodate the one or more magnets 134 of magnetic system 130. As non-limiting examples, device body 110 may be formed from one or more of a polymer, wood, ceramic, non-ferromagnetic metal, or other suitable material. A chemical resistant plastic, for example, may be used for device body 110 in scenarios where cleaning system 100 is used in combination with cleaning solutions or solvents, such as acetone.

In at least some examples, magnetic system 130 is configured to generate a magnetic field having a strength that is adjustable by a user or programmatically adjustable by a machine to thereby achieve a target magnetic force that urges abrasive layer 120 against surface 104. Once the strength of the magnetic field generated by magnetic system 130 has been selected or otherwise adjusted to achieve a target magnetic field strength, the magnetic field and the corresponding magnetic force 132 with respect to a surface of a ferromagnetic object may remain constant, thereby providing a consistent cleaning rate across the surface.

In the example depicted in FIG. 1, upper surface 114 of device body 110 includes a height dimension 142 measured relative to guide face 112 that varies between a nose end 144 and a rear end 146 of the device body. For example, height dimension 142 may taper from an intermediate location, between rear end 146 and nose end 144 of the device body, towards the nose end to provide a control surface that is suitable for a human hand to manipulate cleaning system 100 by translating the cleaning system in its primary cleaning direction 140. For example, the control surface may be adapted to receive a palm of a human hand.

Cleaning system 100 is depicted in simplified form in FIG. 1. Accordingly, cleaning system 100 may take other suitable forms as described in further detail with reference to the example configurations of FIGS. 2-14. Furthermore, surface 104 and ferromagnetic object 102 are depicted schematically in FIG. 1, and may take other shapes or forms.

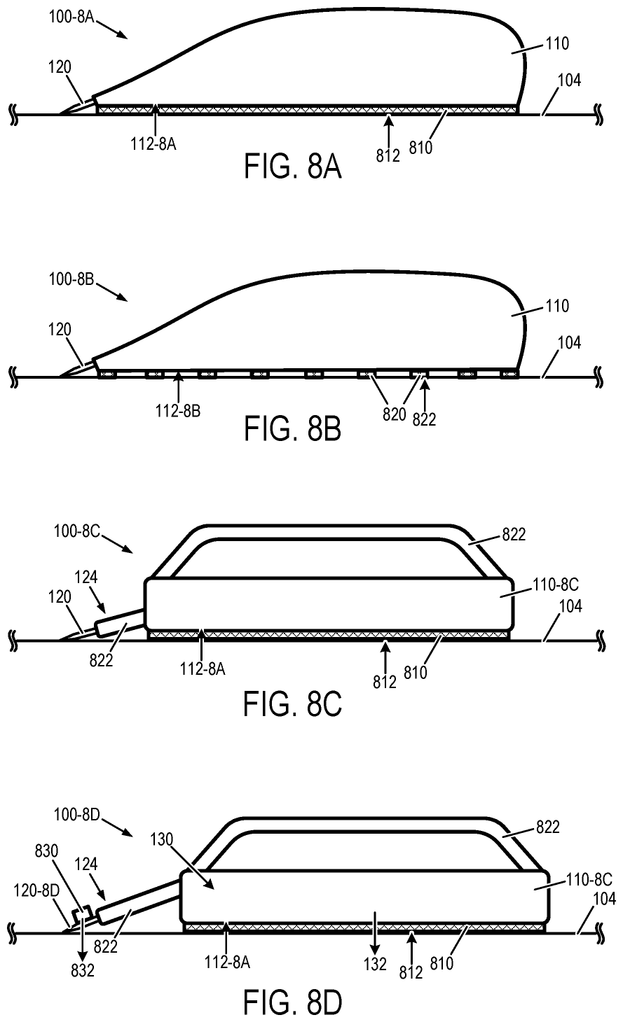

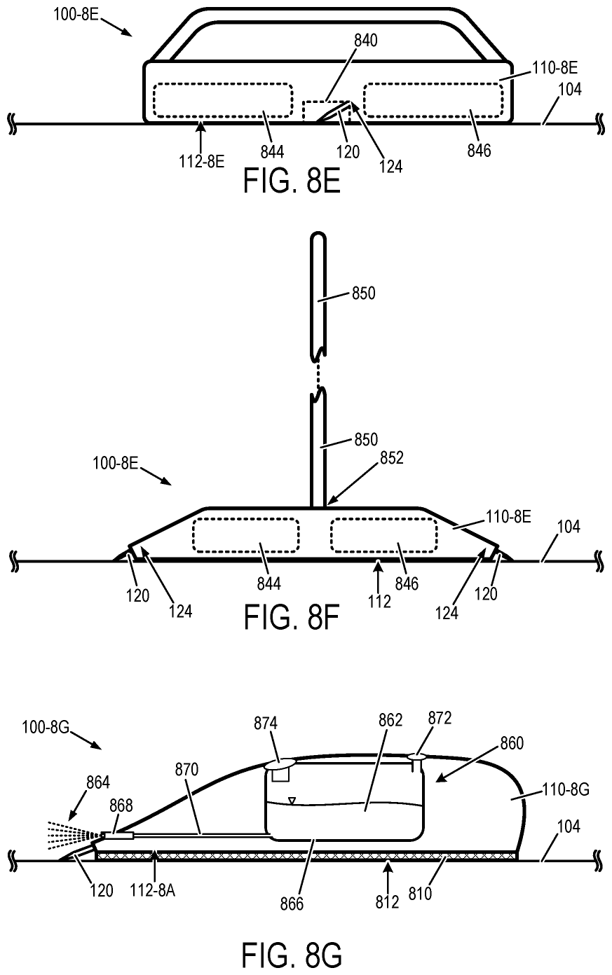

FIG. 2 depicts scraper blade 120 of FIG. 1 projecting outward from device body 110 at an example fixed orientation, represented by a midplane 210 of the thinnest dimension of the scraper blade. Scraper blade 120 is depicted from a side view in a direction that is orthogonal to guide face 112. In this example, scraper blade 120 projects outward from device body 110 at a leading edge or nose end 144 of guide face 112. However, scraper blade 120 may instead project outward from an intermediate location or region along guide face 112 between nose end 144 and rear end 146, such as depicted in FIG. 8E, for example.

The orientation of scraper blade 120 may be defined by a first angle 212 measured relative to a surface normal 214 of surface 104 at a point of contact with the scraper blade at leading edge 122. In this example, scraper blade 120 is inclined relative to surface normal 214, as indicated by first angle 212. First angle 212 may be between approximately 70 degrees and 40 degrees in a specific example. However, other suitable angles beyond this range may be used for first angle 212. In at least some examples, first angle 212 may be selected based on a shape or profile of the scraper blade.

The orientation of scraper blade 120 may also be defined by a second angle 216 measured relative to guide face 112. In this example, scraper blade 120 is inclined relative to guide face 112, as indicated by second angle 216. Second angle 216 may be between approximately 20 degrees and 50 degrees in a specific example. However, other suitable angles beyond this range may be used for second angle 216. In at least some examples, second angle 216 may be selected based on a shape or profile of the scraper blade.

FIG. 2 further depicts an example configuration of scraper blade mount 124 in further detail. In this example, scraper blade mount 124 includes a fastener 220 that spans a channel 222 within which scraper blade 120 is retained. By tightening fastener 220 via adjustment interface 126, opposing sides of channel 222 may be closed and compressed onto scraper blade 120, thereby retaining scraper blade 120 at a fixed position. Conversely, by loosening fastener 220 via adjustment interface 126, opposing sides of channel 222 may be opened, thereby releasing scraper blade 120 from channel 222. Thus, scraper blade mount 124 allows a distance 230 that scraper blade 120 projects outward from device body 110 to be selectively adjusted by moving the scraper blade to a desired position and then tightening fastener 220 to retain the scraper blade at that position. Adjustment interface 126 may include a tool interface (e.g., a hex or Philips head) or a finger-adjustable interface (e.g., a wingnut or quick-release lever) to lock or unlock the scraper blade from the scraper blade mount.

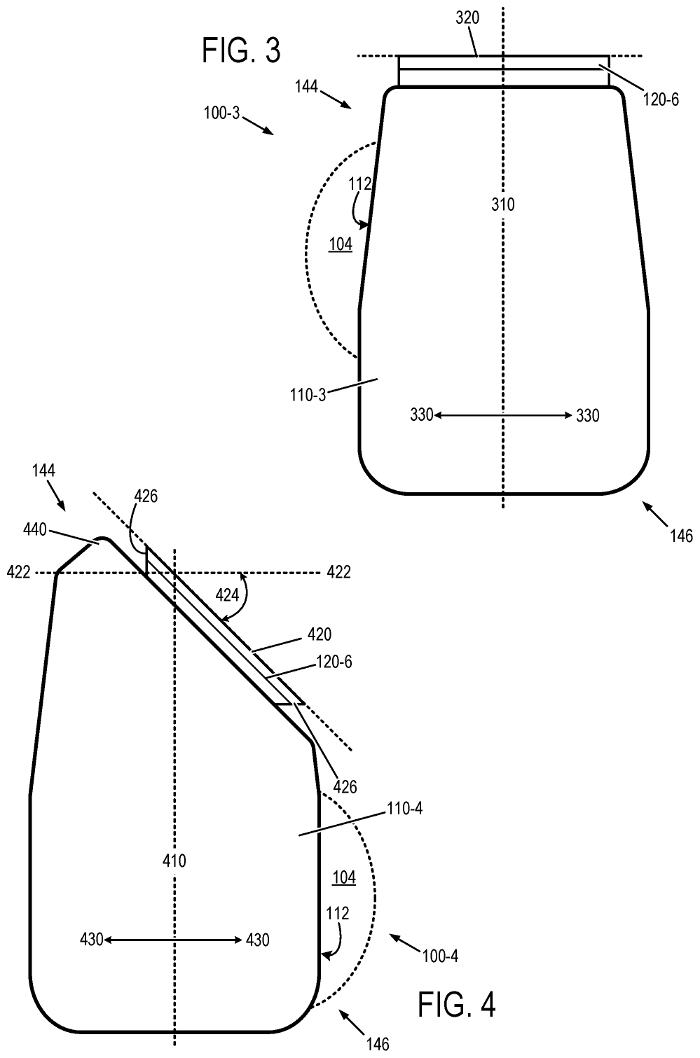

FIG. 3 depicts cleaning system 100-3 as an example configuration of cleaning system 100 of FIG. 1. Within FIG. 3, cleaning system 100-3 is viewed from above in which guide face 112 is resting upon surface 104 of ferromagnetic object 102. Cleaning system 100-3 includes a device body 110-3 that is elongate along a long axis 310. Long axis 310 is parallel to guide face 112 that is in contact with surface 104 and may be parallel to the primary cleaning direction of the cleaning system (e.g., direction 140 of FIG. 1). In this example, cleaning system 100-3 includes scraper blade 120-6 disposed at a fixed orientation in which a leading edge 320 of the scraper blade is orthogonal to long axis 310. Further, in this example, device body 110-3 tapers in a width dimension 330 as measured relative to long axis 310 from rear end 146 to nose end 144 of the device body. This configuration may provide a control surface that is suitable for a human hand to manipulate cleaning system 100. For example, a palm of a hand may be placed at our near rear end 146 while fingers of the hand may be placed along the device body within the tapered region formed between nose end 144 and rear end 146.

While FIG. 3 depicts an example scraper blade orientation in which the leading edge is orthogonal to a long axis of the device body and/or the primary cleaning direction of the cleaning system, in the example depicted in FIG. 4, the leading edge of the scraper blade may be disposed at a non-orthogonal angle (e.g., 45 degrees) relative to the long axis of the device body and the primary cleaning direction of the cleaning system. This angle may be referred to as a setback angle that may improve the ability for the scraper blade to remove contaminants from a surface. For example, the setback angle may allow tape, tape residue, or other contaminants to be ejected upward and away from the leading edge of the scraper blade, whereas a blade that is orthogonal to the long axis and/or the primary cleaning direction may experience residue buildup. This setback angle may provide a blade orientation having a compound angle in combination with the angle that the scraper blade is inclined relative to the guide face and/or surface normal, such as previously described with reference to FIG. 2.

FIG. 4 depicts cleaning system 100-4 as another example configuration of cleaning system 100 of FIG. 1, including a scraper blade having a setback angle. Within FIG. 4, cleaning system 100-4 is viewed from above in which guide face 112 is resting upon surface 104 of ferromagnetic object 102. Cleaning system 100-4 includes a device body 110-4 that is elongate along a long axis 410. Long axis 410 is parallel to a guide face of device body 110-4 that is in contact with surface 104, and may be parallel to the primary cleaning direction of the cleaning system (e.g., direction 140 of FIG. 1). In this example, cleaning system 100-4 includes scraper blade 120-6 having a leading edge 420 that is disposed at a non-orthogonal angle relative to long axis 410. For purposes of clarity with respect to setback angle measurements, an angle of leading edge 420 may be defined relative to an orthogonal axis 422 to long axis 410. For example, as depicted in FIG. 4, leading edge 420 is disposed at a setback angle 424 that is an acute angle relative to orthogonal axis 422. Setback angle is approximately 45 degrees in an example. However, other suitable values for setback angle 424 may be used, including angles between greater than 0 degrees and approximately 45 degrees. It will be understood that a setback angle and/or a compound angle for the scraper blade, such as described with reference to FIG. 4, may be used with any of the example cleaning system configurations describe herein.

Scraper blade 120-6 in the example of FIG. 4 has exterior edges 426 that taper inward and away from leading edge 420 towards the device body. This tapering of exterior edges 426 may improve performance of scraper blade 120, particularly if used with a setback angle. For example, where setback angle 424 is 45 degrees, a taper having an angle of 45 degrees for exterior edges 426 may be used so that exterior edges 426 do not face in the primary cleaning direction of the cleaning system. This configuration may reduce or preclude contact of exterior edges 426 with surface 104 or contaminants to be removed from the surface during use of the cleaning system.

Furthermore, in the example depicted in FIG. 4, device body 110-4 tapers in a width dimension 430 as measured relative to long axis 410 from a rear end 146 to a nose end 144 of the device body. This configuration may provide a control surface that is suitable for a human hand to manipulate cleaning system 100. For example, a palm of a hand may be placed at our near rear end 146 while fingers of the hand may be placed along the device body within the tapered region formed between nose end 144 and rear end 146. Additionally, a nose portion 440 of device body 110-4 may project beyond scraper blade 120-6 as measured along long axis 410. In this configuration, nose portion 440 may reduce impact of the scraper blade against objects that project from surface 104 (e.g., walls) when the cleaning system is operated in the primary cleaning direction. Similarly, an exterior profile of device body 110-6 in width dimension 430 may extend beyond scraper blade 120-6 to further reduce impact of the scraper blade against objects that project from surface 104 (e.g., walls)

FIG. 5 depicts example configurations of magnetic system 130 of FIG. 1 in further detail in relation to device body 110-5. Within FIG. 5, device body 110-5 is shown in simplified form as an example of device body 100 of FIG. 1, in which guide face 112 is urged against surface 104 by a magnetic force 132 provided by magnetic system 130.

In a first configuration of magnetic system 130 depicted at 510, device body 110-5 defines one or more receptacles 512 that each accommodate one or more magnets 502. Each instance of magnet 502 may take the form of a permanent magnet that generates a persistent magnetic field of a particular strength. The one or more receptacles 512 may be formed within a side, top, or bottom surface (e.g., guide face 112) of device body 110-5 to provide side-loading, top-loading, or bottom-loading configurations, respectively. Furthermore, in at least some examples, each of receptacles 512 may have a depth that accommodates one or more of magnets 502 such that the one or more magnets inserted into the receptacles are fully contained within an outer perimeter of the device body in a region surrounding the receptacle. The device body may include a cover portion for each receptacle in at least some examples.

In a second configuration of magnetic system 130 depicted at 520, device body 110-5 includes one or more mounts 522 that each accommodate one or more magnets 504. The one or more mounts 522 may be formed on a side, top, or bottom surface (e.g., guide face 112) of device body 110-5 to provide side-mounting, top-mounting, or bottom-mounting configurations, respectively. In this example, each mount 522 includes a mounting surface 524 and a fastener component 526 that secures one or more respective magnets 504 to the mounting surface. For example, fastener component 526 may take the form of a bolt that passes through an opening 506 formed in magnets 504 where it may engage with a corresponding fastener component 528 of mounting surface 524 (e.g., a tapped opening) to secure the one or more magnets to the device body. It will be understood that fastener components 528 and 526 may take other suitable forms. Furthermore, in at least some examples, mounting surface 524 of each mount may be recessed into the device body at a depth that accommodates one or more of magnets 502 such that the one or more magnets are fully recessed below the outermost surface of the device body in a region surrounding the mounting surface, such as previously described with reference to the receptacles of the first configuration depicted at 510. The device body may include a cover portion for each recessed mounting surface in at least some examples.

In a third configuration of magnetic system 130 depicted at 530, device body 110-5 includes one or more receptacles 532 that each accommodate a corresponding cradle 534. Cradle 534 defines a payload region 536 that accommodates one or more of magnets 502. The one or more receptacles 532 may be formed on a side, top, or bottom surface (e.g., guide face 112) of device body 110-5 to provide side-loading, top-loading, or bottom-loading configurations, respectively. In an example, cradle 534 that is loaded into receptacle 532 of device body 110-5 may be retained within the receptacle by one or more fastener components 542 that pass through and/or received by a portion of device body 110-5 (e.g., as indicated by opening 540) and a portion of cradle 534 (e.g., as indicated by opening 544). However, other suitable fasteners may be used to retain cradle 534 within receptacle 532. In at least some examples, an exterior facing surface of cradle 534 may be flush with an exterior surface of device body 110-5 surrounding the receptacle when the cradle is loaded into the receptacle.

Magnetic system 130 may include a plurality of magnets 550 of which the previously described instances of magnet 502 are members. In at least some examples, the plurality of magnets 550 may include one or more additional magnets 552 that generate a magnetic field having a different strength than magnets 502. Magnets 552 may also take the form of permanent magnets that generate a persistent magnetic field of a particular strength.

In at least some examples, the magnetic field generated by magnetic system 130 is adjustable to vary magnetic force 132 urging guide face 112 against surface 104 by adding or removing one or more permanent magnets to or from the device body. For example, in each of the example configurations depicted at 510, 520, and 530, instances of permanent magnets 502 may be added or removed from the device body to respectively increase or decrease the strength of the magnetic field generated by magnetic system 130 and the corresponding magnetic force 132. Alternatively or additionally, in each of the example configurations depicted at 510, 520, and 530, instances of permanent magnets 502 may be replaced with instances of permanent magnets 552 that generate a magnetic field of a different strength to thereby increase or decrease the strength of the magnetic field generated by magnetic system 130 and thereby adjust the corresponding magnetic force 132. Alternatively or additionally, a position of the one or more permanent magnets may be varied relative to guide face 112 to increase or decrease strength of the magnetic field at the guide face, thereby increasing or decreasing magnetic force 132. For example, a spacer may be placed between mounting surface 524 and an instance of magnet 502 to change a distance between that magnet and guide face 112. As another example, one or more magnets may be moved between a first receptacle or mount that is closer to guide face 112 and a second receptacle or mount that is further from guide face 112 to varying magnetic force 132. Additionally or alternatively, an abrasive layer or reduced-friction layer of a particular thickness may be added to guide face 112 to increase a distance between the magnets of the magnetic system and the ferromagnetic object, thereby decreasing the magnetic force. Such layers may be removed to reduce the distance between the ferromagnetic object and the magnets of the magnetic system, thereby increasing the magnetic force. Example layers that may be used with guide face 112 are described in further detail with reference to FIG. 8A.

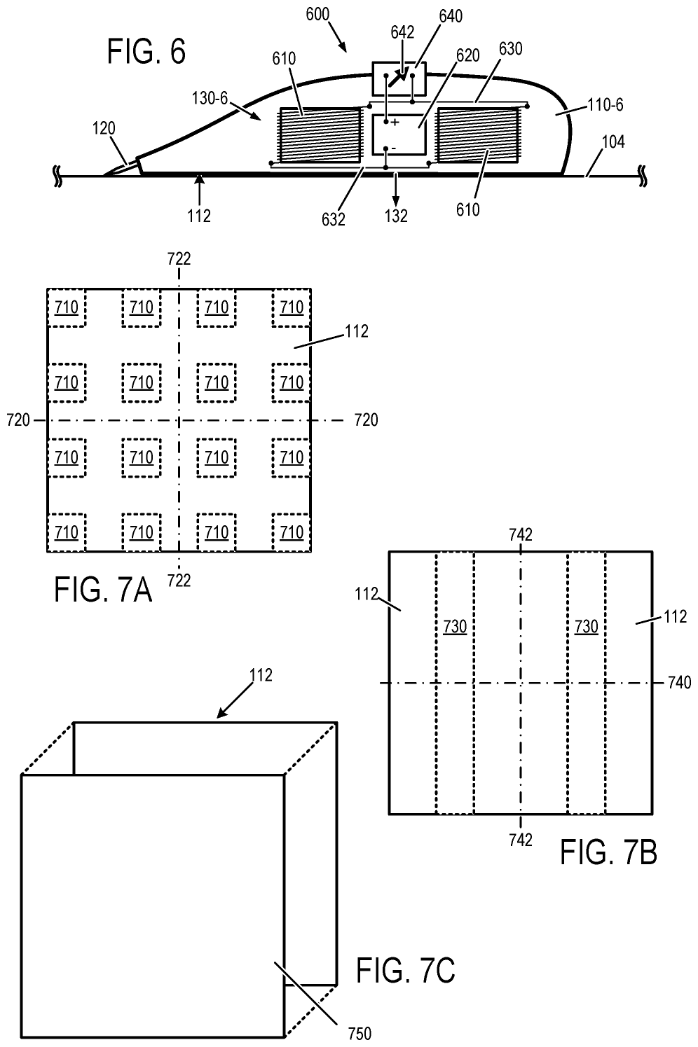

FIG. 6 depicts magnetic system 130-6 as an example configuration of magnetic system 130 of FIG. 1 in relation to an example device body 110-6. In this example, magnetic system 130-6 includes one or more electromagnets 610. Within FIG. 6 device body 110-6 is depicted in a side view through a section of the device body with guide face 112 being urged against surface 104 by magnetic force 132 generated by electromagnets 610 of magnetic system 130-6.

In the example depicted in FIG. 6, the one or more electromagnets 610 are disposed within device body 110-6. However, in other examples, the one or more electromagnets may be mounted upon an exterior of device body 110-6, such as previously described with respect to the mounts 522 of FIG. 5, for example. The one or more electromagnets 610 may form part of an electronic circuit 600 of magnet system 130-6. Electronic circuit 600 may further include an electrical power source 620 that supplies electrical energy (e.g., electrical current) to the one or more electromagnets 610 via electrically conductive pathways 630 and 632. Electrical power source 620 may include an on-board power supply (e.g., one or more batteries) and/or an electrical interface to an off-board power supply (e.g., an electrical cord interfacing with an external power supply via an electrical outlet).

Electronic circuit 600 may further include an electronic controller 640 that varies electrical current supplied to the one or more electromagnets 610 from electrical power source 620 responsive to a control input (e.g., a user input) to generate a magnetic field via the one or more electromagnets having an adjustable strength. For example, electronic controller 640 may include a control interface 642 by which a user input may be received, enabling a user to set a strength of the magnetic field produced by the one or more electromagnets 610 to achieve a target magnetic field and corresponding magnetic force. Control interface 642 may include one or more buttons, switches, sliders, graphical user interfaces, etc. operable by a user to vary the electrical power and/or current supplied to the electromagnets from the electrical power source 620 via electronic controller 640. Alternatively, or additionally, electronic controller 640 may programmatically adjust (e.g., responsive to a control input) the magnetic field generated by the electromagnets to achieve a target magnetic field and corresponding magnetic force. In at least some examples, once the magnetic field produced by the electromagnets and the corresponding magnetic force 132 have been set by adjusting a strength of the magnetic field, the magnetic field may be maintained at a constant strength, thereby enabling the surface of the ferromagnetic object to be consistently cleaned at an appropriate rate through manipulation of the device body.

The example configurations described with reference to FIGS. 5 and 6 may be used individually or combination to obtain a variety of magnetic system configurations that include permanent magnets and/or electromagnets. FIGS. 7A-7C depict additional configurations of magnets in relation to guide face 112.

FIG. 7A depicts an example configuration of magnets 710 in relation to guide face 112. In this example configuration, magnets 710 are arranged in a two-dimensional matrix that is symmetric about a first midplane 720 and a second midplane 722 of the device body that are orthogonal to each other. A symmetric configuration of magnets (e.g., 710) about one or more midplanes of a device body may provide an even distribution of magnetic force along guide face 112 in one or two dimensions.

FIG. 7B depicts an example configuration of magnets 730 in relation to guide face 112. In this example, magnets 730 span guide face 112 along a first axis (e.g., oriented along midplane 742), and are symmetrically arranged about both a first midplane 740 and a second midplane 742 that are orthogonal to each other. This symmetric configuration of magnets (e.g., 730) about one or more midplanes of a device body may again provide an even distribution of magnetic force across guide face 112 in one or more two dimensions.

FIG. 7C depicts an example configuration in which one or more sheet magnets 750 span a portion of or the entirety of guide face 112. In examples where one or more magnets 750 span the entirety of guide face 112, an even distribution of magnetic force may be provided across the guide face in two dimensions.

FIG. 8A depicts cleaning system 100-8A as an example configuration of cleaning system 100 of FIG. 1. Within FIG. 8A, cleaning system 100-8A is viewed from a side view within a plane that is orthogonal to guide face 112-8A. In this example, guide face 112-8A further comprises a surface-interfacing layer 810 configured to contact surface 104 of the ferromagnetic object. Layer 810 may be removably mounted to the guide face using a variety of suitable techniques, including hook and loop, adhesive, and/or mechanical fasteners. Mechanical fasteners may be recessed beneath an outer-facing surface of layer 812 or may be provided along one or more exterior edges of the device body. While features of layer 810 are described in further detail below, it will be understood that such features may be integrated directly into the guide face of the device body in at least some examples.

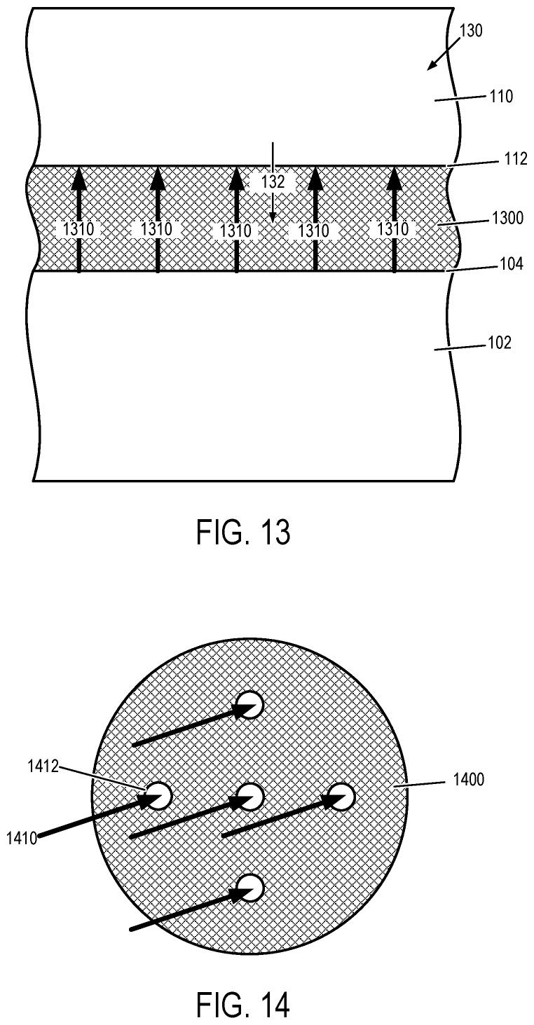

In a first example, surface-interfacing layer 810 includes an outward-facing surface 812 in the form of an outward-facing abrasive surface that may be used in combination with scraper 120 to clean surface 104. Within this configuration, guide face 112-8A may be referred to as an abrasive guide face or a cleaning face of the device body, and layer 810 may be referred to as an abrasive layer. Examples of abrasive layers are described in further detail with reference to FIGS. 13 and 14. In further examples, the guide face and/or device body may be formed of an abrasive material to incorporate the outer-facing abrasive surface of layer 810 directly into the guide face.

In a second example, outward-facing surface 812 of surface-interfacing layer 810 make instead take the form of an outward-facing reduced-friction surface having a lower coefficient of friction as compared to the guide face and/or a material from which the device body is formed. This reduced-friction surface may include a non-abrasive, low friction surface of Teflon or Armarlon tape, for example. In further examples, the guide face and/or device body may be formed of a non-abrasive, low-friction material, such as Teflon.

FIG. 8B depicts cleaning system 100-8B as an example configuration of cleaning system 100 of FIG. 1. Within FIG. 8B, cleaning system 100-8B is viewed from a side view within a plane that is orthogonal to guide face 112-8B. In this example, guide face 112-8B further comprises a plurality of protrusions 820 configured to contact surface 104 of the ferromagnetic object. Protrusions 820 may be distributed over guide face 112-8B in both the long axis and the width dimension of the device body to support the cleaning system upon the surface. Protrusions may take the form of localized protrusions (e.g., feet) or ridges that span some or all of the guide face in a particular dimension, as examples. Protrusions 820 may each include an outward facing surface 822. In a first example, outward-facing surface 822 may take the form of an outward-facing abrasive surface that may be used in combination with scraper 120 to clean surface 104. In a second example, outward-facing surface 822 may instead take the form of an outward-facing reduced-friction surface having a lower coefficient of friction as compared to other portions of the guide face that do not contact the surface and/or as compared to a material from which the device body is formed. Protrusions 820 of FIG. 8B may replace any of the surface-interfacing layers described herein with respect to the guide face. Furthermore, it will be understood that any of the guide faces described herein may further comprise protrusions 820, as described with reference to FIG. 8B.

FIG. 8C depicts cleaning system 100-8C as an example configuration of cleaning system 100 of FIG. 1. Within FIG. 8C, cleaning system 100-8C is viewed from a side view within a plane that is orthogonal to previously described guide face 112-8A of FIG. 8A. However, in this example, device body 110-8C includes a handle that may be used to manipulate cleaning system 100-8C, which may include moving device body 110-8C in a scrubbing motion to clean surface 104 via an abrasive of guide face 112-8A. Furthermore, in this example, device body 110-8C includes an arm portion 822 that includes scraper blade mount 124 that retains scraper blade 120 at a fixed orientation. This configuration, including arm portion 822 may be used to increase a distance between a control surface of the device body by which the cleaning system is manipulated and a point of contact of the scraper blade with the surface of the ferromagnetic object.

FIG. 8D depicts cleaning system 100-8D as an example configuration of cleaning system 100 of FIG. 1, incorporating some of the previously described features of FIGS. 8A and 8C. Within FIG. 8D, cleaning system 100-8D is viewed from a side view within a plane that is orthogonal to previously described guide face 112-8A of FIG. 8A. However, in this example, scraper blade 120-8D includes a blade-mounted magnetic system 832 that is separate from the magnetic system 130 of the device body. Blade-mounted magnetic system 830 may take the form of any of the magnetic systems described herein with respect to the device body. For example, blade-mounted magnetic system 830 may include one or more permanent magnets and/or electromagnets. Blade-mounted magnetic system 830 is configured to generate a magnetic field that urges scraper blade 120-8D against surface 104 by a magnetic force 832. In this configuration, blade 120-8D may be formed from a non-ferromagnetic material, such as ceramic, plastic, or a metal having relatively low magnetic interaction to thereby reduce interaction between magnetic system 830 and the scraper blade. Furthermore, in this configuration, arm portion 822 may be configured to flex along its length at an interface between the scraper blade and the device body to enable magnetic force 832 to be independently applied at the scraper blade from magnetic force 132 that is applied at the guide face. This configuration may enable different forces to be applied at the scraper blade and at an abrasive of the guide face, for example. For example, magnetic system 830 may incorporate any of the features described with reference to magnetic system 130 that enable the strength of the magnetic field and the corresponding magnetic force 832 to be adjusted.

FIG. 8E depicts cleaning system 100-8E as an example configuration of cleaning system 100 of FIG. 1. Within FIG. 8E, cleaning system 100-8A is viewed from a side view within a plane that is orthogonal to guide face 112-8E. In this example, scraper blade 120 projects outward from device body 110-8E to contact surface 104 at an intermediate region of the guide face (e.g., along a long axis of the guide face). This configuration may be referred to as a mid-mounted configuration of the scraper blade in contrast to the nose-mounted configuration of FIG. 2. As one example, guide face 112-8E may include an opening 840 formed in the device body through which scraper blade 120 projects outward to contact surface 104. Scraper blade 120 retained in a fixed orientation by blade mount 124 that is located in the vicinity of the intermediate region of the guide face, as opposed to a leading edge or nose of the device body, such as previously described with reference to FIG. 2. Furthermore, in this configuration, the magnetic system may include one or more permanent magnets and/or electromagnets represented schematically at 844 and 846 that are located on each side of opening 840 to provide a magnetic force that urges guide face 112-8E against surface 104 on each side of scraper blade 120. This configuration may serve to distribute the magnetic force more evenly over the guide face. The mid-mounted configuration of FIG. 8E may replace any of the nose-mounted configurations described herein with respect to the scraper blade.

FIG. 8F depicts cleaning system 100-8F as an example configuration of cleaning system 100 of FIG. 1. Within FIG. 8F, cleaning system 100-8F is viewed from a side view within a plane that is orthogonal to guide face 112. In this example, device body 110-8E includes multiple instances of scraper blade 120 and associated scraper blade mount 124. Also in this example, the multiple instances of scraper blade 120 and associated mount 124 face in opposing directions in the example depicted in FIG. 8F. For example, device body 110-8E includes two nose-mounted scraper blades located at opposite ends of the device body (e.g., along a long axis of the device body). However, in another example, the device body may include two opposing mid-mounted scraper blades, such as at an intermediate location of the guide face as previously described with reference to FIG. 8E. This configuration of opposing scraper blades may enable surface 104 to be cleaned by respective instances of scraper blade 120 using forward and backward movements along an axis of primary cleaning direction 140 depicted in FIG. 1. In still further examples, two or more instances of scraper blade 120 and associated mount 124 may be oriented in the same direction, and may be provided along the same long axis of the device body to enable a surface to be cleaned by the two or more scraper blades using a single pass of the cleaning system over the surface. For example, a first nose-mounted scraper blade and a second mid-mounted scraper blade may be provided along the same long axis of the device body.

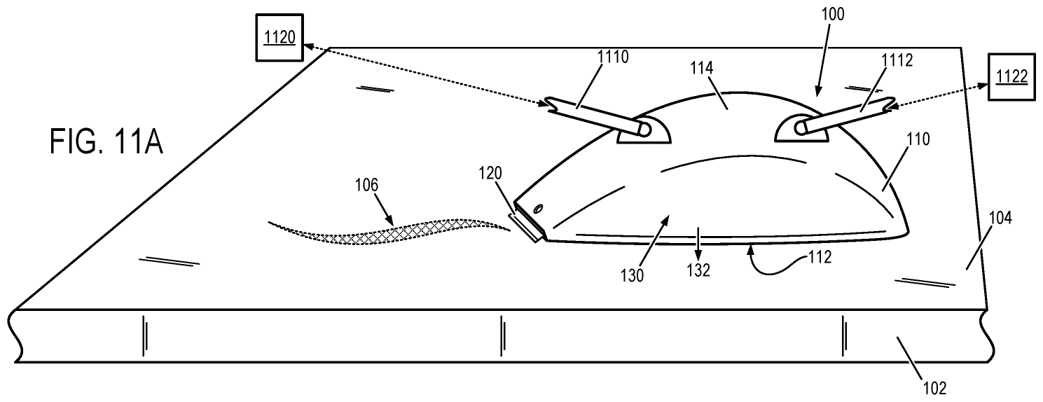

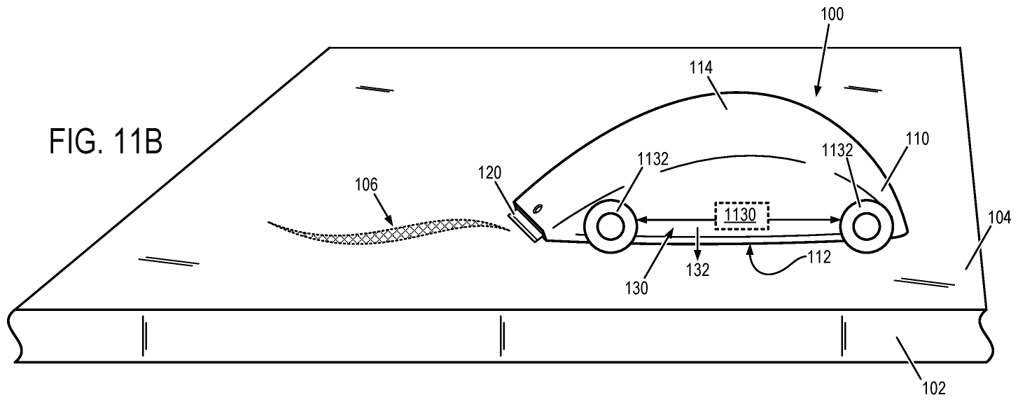

Furthermore, FIG. 8F depicts an example of device body 110-8E being incorporated with a handle 850 having an individual point of contact to the device body at 852. Handle 850 may take the form of a boom handle or mechanical linkage, such as described with reference to FIG. 11A, for example. Handle 850 may pivot relative to device body 110-8E about point of contact 852, in at least some examples. In the configuration of FIG. 8F, one or more of magnets 844 and 846 may be provided on each side of the device body with respect to point of contact 852 to provide a magnetic force that is evenly distributed along guide face 112 about the point of contact 852 and evenly distributed with respect to two instances of scraper blade 120.

FIG. 8G depicts cleaning system 100-8G as an example configuration of cleaning system 100 of FIG. 1. Within FIG. 8G, cleaning system 100-8G is viewed from a side view within a plane that is orthogonal to previously described guide face 112-8A of FIG. 8A. In this example, device body 110-8G incorporates a cleaning fluid dispensing system 860 that may be used to dispense a liquid cleaning fluid 862 from the cleaning system, as indicated schematically at 864. Cleaning fluid dispensing system 860 may include a fluid tank 866 located within the device body, a spray nozzle 868 located along an exterior surface of the device body, and internal fluid pathway 870 connecting the fluid tank to the spray nozzle. Cleaning fluid dispensing system 860 may further include a fill cap and associated pathway 872 that enables cleaning fluid to be added to fluid tank 866. Cleaning fluid dispensing system 860 may further include a mechanical pump 874 that may be hand operated by a user to generate sufficient pressure within fluid tank 866 to dispense the cleaning fluid, for example, as a spray via the spray nozzle. As one example, mechanical pump 874 may take the form of a collapsible bulb located on an exterior surface of the device body that may be compressed by the user (e.g., via a finger or a palm of the hand) to increase the internal pressure within fluid tank 866 and thereby dispense fluid from the spray nozzle. However, mechanical pump 874 may alternatively include a trigger or button-actuated pump. Furthermore, in at least some examples, mechanical pump 874 may include an electro-mechanical pump that is electrically powered by an on-board power source or by an external power supply, such as an electrical outlet. In this example, the pump may include a control interface to dispense the cleaning fluid, such as previously described with reference to control interface 642 of FIG. 6. It will be understood that cleaning fluid dispensing system 860 or variations thereof may be incorporated into any of the example cleaning systems disclosed herein.

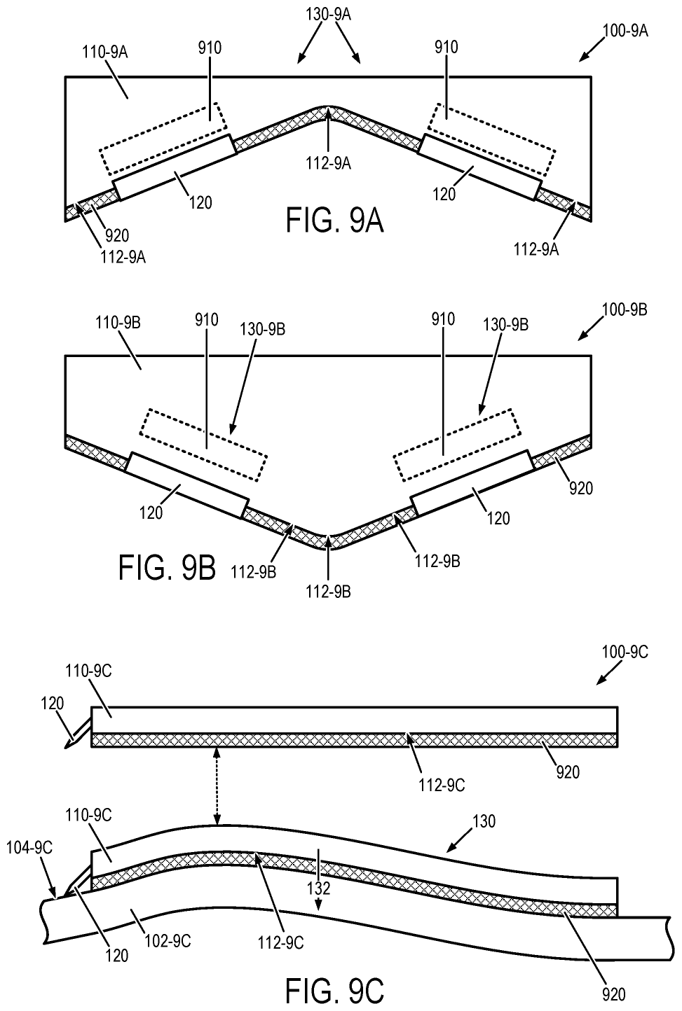

Within the preceding examples, guide face 112 is depicted as a planar guide face. However, guide face 112 may take other suitable forms for cleaning ferromagnetic objects having curved surfaces. FIGS. 9A, 9B, and 9C depict example device body configurations that provide a non-planar guide face.

FIG. 9A depicts example device body 110-9A of cleaning system 100-9A that defines a concave guide face 112-9A that is suitable for conforming to and/or cleaning a convex surface of a ferromagnetic object. In this example, guide face 112-9A further includes a surface-interfacing layer 920 may include an outward-facing abrasive surface or a reduced-friction surface. However, layer 920 may be omitted in at least some examples. Magnetic system 130-9A may include one or more magnets 910 associated with respective regions (e.g., portions of the guide face) of device body 110-9A to provide a distribution of magnetic force across concave guide face 112-9A. Within FIG. 9A, respective instances of scraper blade 120 are depicted at example locations, such as on opposite sides of concave guide face 112-9A as viewed from a nose end of the device body.

FIG. 9B depicts example device body 110-9B of cleaning system 100-9B that defines a convex guide face 112-9B for conforming to and/or cleaning a concave surface of a ferromagnetic object. Magnetic system 130-9B may include one or more magnets 910 associated with respective regions of device body 110-9B to provide a distribution of magnetic force across convex guide face 112-9B. In this example, guide face 112-9B again includes surface-interfacing layer 920, which may be omitted in at least some examples. Within FIG. 9B, respective instances of scraper blade 120 are depicted at example locations, such as on opposite sides of convex guide face 112-9A as viewed from a nose end of the device body.

It will be understood that any of the various configurations of device body 110 disclosed herein may be flexible to allow guide face 112 and/or a surface-interfacing layer thereof to wholly or partially conform to a shape of a surface of a ferromagnetic object to be cleaned by the cleaning system. For example, FIG. 9C depicts an example device body 110-9C having a first shape (e.g., an initially planar guide face 112-9C) that conforms to example surface 104-9C of example ferromagnetic object 102-9C upon magnetic force 132 that is generated by the magnetic system urging the device body against the surface. Flexibility of the device body of cleaning system 100-9C may be obtained by a configuration of the device body (e.g., a device body having a thickness in a dimension normal to the surface that enables the device body to flex under an applied force) and/or a material from which the device body is formed. Guide face 112-9C of FIG. 9C further includes surface-interfacing layer 920 in this example, which may be omitted in other examples. Furthermore, in this example, scraper blade 120 is depicted at an example location, such as projecting from a nose end of device body 110-9C, which in FIG. 9C is viewed from a side view within a plane that is orthogonal to guide face 112-9C.

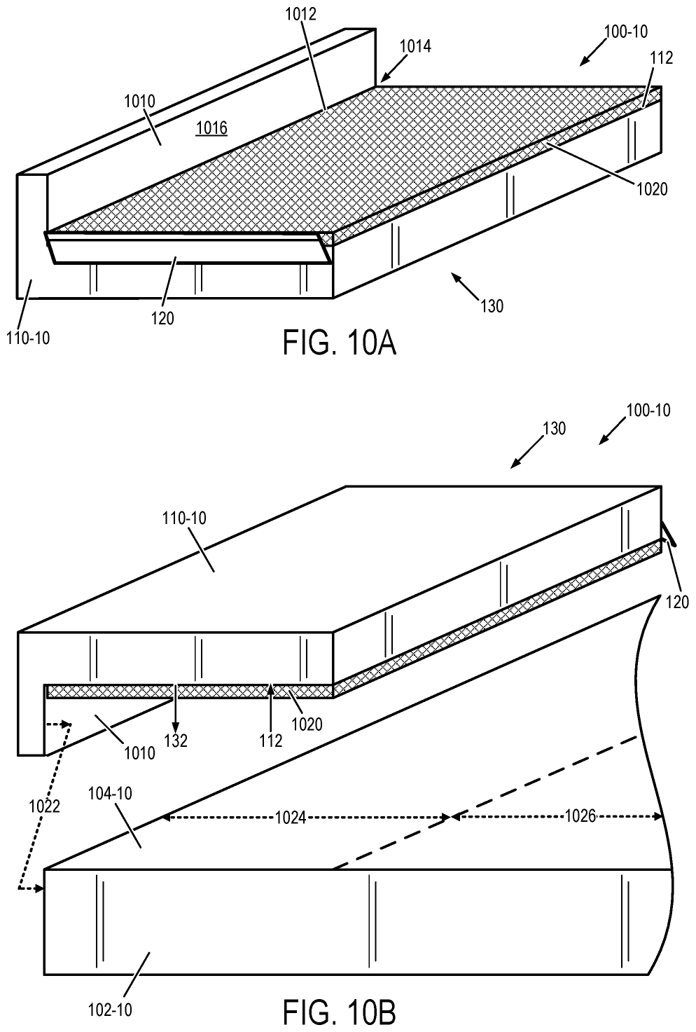

FIGS. 10A and 10B depict another example configuration of device body 110 of cleaning system 100 as device body 110-10 of cleaning system 100-10. FIG. 10A depicts a view of device body 110-10 from a side that includes guide face 112 and FIG. 10B depicts a view of device body 110-10 from an opposite side with guide face 112 facing toward example surface 104-10 of example ferromagnetic object 102-10. Furthermore, in FIG. 10A, an example fixed orientation of blade 120 is depicted in relation to device body 110-10. In this example, guide face 112 further comprises a surface-interfacing layer 1020, which may include an outward-facing abrasive surface or an outward-facing reduced-friction surface, depending on implementation.

Device body 110-10 in this example further includes an additional guide face 1010 projecting outward from a first edge 1012 of guide face 112 to form an interior-facing corner 1014 with guide face 112. While FIG. 10A depicts the additional guide face 1010 extending continuously along the entirety of first edge 1012, it will be understood that this additional guide face may take other forms including two or more guide face sections that are spaced apart from each other along first edge 1012, and so forth.

In FIG. 10B, guide face 112 and scraper blade 120 may be urged against surface 104-10 by magnetic force 132. Furthermore, a surface 1016 of additional guide face 1010 may be placed in contact with an exterior edge of surface 104-10 as indicated at 1022 in FIG. 10B, for example to limit cleaning of surface 104-10 to an edge region 1024 by scraper blade 120 and/or an abrasive of surface-interfacing layer 1020. Accordingly, an interior region 1026 of surface 104-10 may be precluded from contact with scraper blade 120 and/or an abrasive of surface-interfacing layer 1020 by the use of the additional guide face 1010. In at least some examples, surface 1016 of the additional guide face 1010 may include a non-abrasive surface and/or low friction layer (e.g., Teflon or Armarlon tape) similar to the reduced-friction surfaces disclosed herein for guide face 112 to reduce cleaning and/or wear to an edge of a ferromagnetic object. In further examples, additional guide face 1010 or device body 110-10 may be formed of a non-abrasive, low-friction material, such as Teflon.

FIG. 10B further depicts an example of magnetic force 132 generated by magnetic system 130 in relation to surface 104-10. Device body 110-10 may comprise magnetic system 130 having any of the various configurations disclosed herein. Device body 110-10 may further include one or more control surfaces, handles, and/or other features to enable the device body to be moved by hand or by machine during cleaning of a surface of a ferromagnetic object.

FIG. 11A depicts an example configuration for moving cleaning system 100 of FIG. 1 in relation to surface 104 of example ferromagnetic object 102. Within FIG. 11A, various features of previously described cleaning system 100 are depicted; however, device body 110 includes one or more mechanical couplings depicted schematically at 1110 and 1112. As an example, mechanical couplings 1110 and 1112 may take the form of rigid or semi-rigid structural members that are capable of transmitting force in both tension and compression directions to device body 110 from one or more remote sources represented schematically at 1120 and 1122. As another example, mechanical couplings 1110 and 1112 may take the form of flexible structural members, such as a cable, chain, belt, or rope that are capable of transmitting force in tension to device body 110 from one or more of remote sources 1120 and 1122. Through operation of remote sources 1120 and/or 1122, device body 110, including scraper blade 120 and/or an outward-facing abrasive surface (if included) of guide face 112 may be translated, rotated, and/or vibrated in relation to surface 104 as part of a cleaning operation. Remote sources 1120 and 1122 may include electro-mechanical actuators, motors, engines, etc. that are capable of moving device body 110 via mechanical couplings 1110 and 1112. In at least some examples, remote sources may be programmatically controlled by a computing system and/or robotics.

FIG. 11B depicts another example configuration for moving cleaning system 100 of FIG. 1 in relation to surface 104 of example ferromagnetic object 102. Within FIG. 11B, various features of previously described cleaning system 100 are depicted; however, device body 110 in this example is self-propelled by an on-board motor 1130 via one or more wheels or treads depicted schematically at 1132. In this configuration, device body 110, including scraper blade 120 and/or an outward-facing abrasive surface (if included) of guide face 112 may be moved at a user-defined or programmatically-defined speed along surface 104 by on-board motor 1130. On-board motor 1130 may be an electrically-powered motor, an air-powered motor, or a combustion-powered motor from on-board or remotely-connected energy sources. In at least some examples, on-board motor 1130 and/or a steering system associated with one or more wheels or treads 1132 may be user-controlled or programmatically controlled from a remote location by a computing system and/or robotics over a wired or wireless network to clean surface 104.

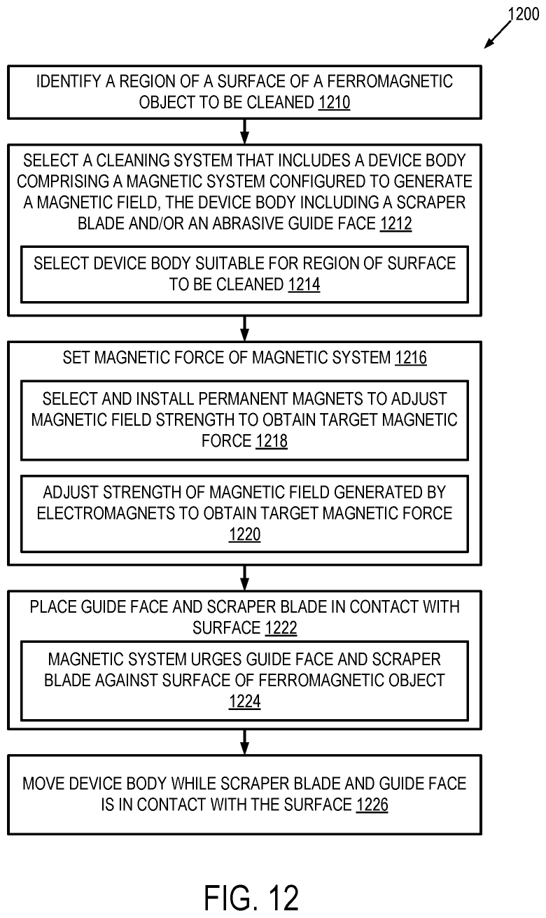

FIG. 12 is a flow diagram depicting an example method 1200 for cleaning a surface of a ferromagnetic object. Aspects of method 1200 may be performed using any of the cleaning systems disclosed herein, including previously described cleaning system 100 of FIG. 1 and the various configurations thereof. It will be understood that method 1200 or portions thereof may be performed by one or more users, one or more machines (including computing system/control system hardware), or by a combination of one or more users and/or machines.

At 1210, the method includes identifying a region of a surface of a ferromagnetic object to be cleaned. As previously described with reference to FIG. 10B, select regions of a surface may be cleaned by operation of cleaning system 100 during a cleaning operation while other regions of the surface are not to be cleaned during the cleaning operation. Within the context of composite layup, for example, regions of a surface of ferromagnetic cure tooling may be coated with a mold-release material that is to be re-used over multiple layup operations, whereas other regions of the surface (e.g., edges of cure tooling to which vacuum bags are taped or adhered) are to be cleaned after each layup operation to remove tape, tape residue, resin and/or other contaminants.

At 1212, the method includes selecting a cleaning system that includes a device body comprising a magnetic system configured to generate a magnetic field. The cleaning system further includes a scraper blade (e.g., scraper blade 120) fixed to the device body. The device body defines a guide face (e.g., guide face 112), which may take the form of an abrasive guide face in at least some examples. The cleaning system selected at 1212 may include any of the cleaning systems disclosed herein.

In at least some examples, the cleaning systems disclosed herein may be manufactured by forming the device body using injection molding, additive manufacturing (e.g., 3D printing), or machining the device body from one or more pieces of raw material. The device body may be combined with a magnetic system, such as in examples where the device body is formed from a non-magnetic material. In at least some examples, one or more magnets may be permanently incorporated into the device body at the time of molding or additive manufacturing of the device body.

A surface-interfacing layer that includes an outward-facing abrasive surface or an outward-facing reduced-friction surface may be mounted to the guide face of the device body. In at least some examples, the surface-interfacing layer of a particular area, thickness, and/or compressibility (stiffness or resistance to deformation), and so forth, may be selected to adjust a strength of the magnetic field generated by the magnetic system in relation to an outward-facing surface of that layer. For example, selecting an abrasive layer having a smaller area for use with a magnetic field of a certain strength may effectively increase the force per unit area to which the abrasive layer is urged against the ferromagnetic object, as compared to an abrasive layer having a larger area with a magnetic field of the same strength. In another example, a thicker and/or less compressible abrasive layer may be selected to reduce the strength of the magnetic field in relation to the outward-facing surface of the abrasive layer that is urged against a ferromagnetic object, or a thinner and/or more compressible abrasive layer may be selected to increase the strength of the magnetic field in relation to the outward-facing surface of the abrasive layer that is urged against the ferromagnetic object. This adjustment to the strength of the magnetic field may be used in addition to or as an alternative to any of the other magnetic field adjustment techniques disclosed herein.

As part of selecting the cleaning system at 1212, the method may additionally include, at 1214, selecting the device body from a plurality of available device bodies that is suitable for the region of the surface to be cleaned. For example, a device body, such as device body 110-10 of FIGS. 10A and 10B that includes an additional guide face 1010 may be selected for a cleaning operation that is limited to region 1024 of FIG. 10B. As another example, a device body having a convex guide face, a concave guide face, or a flexible guide face, such as described with reference to FIGS. 9A, 9B, and 9C, respectively, may be selected for cleaning ferromagnetic objects having non-planar surfaces.

At 1216, the method includes setting a magnetic field and/or a corresponding magnetic force of the magnetic system. The method at 1216 may include adjusting the strength of the magnetic field generated by the magnetic system in relation to the guide face from a first value to a second value to vary the magnetic force urging the guide face against the surface of the ferromagnetic object. As part of setting the magnetic force of the magnetic system, the method at 1218 may include one or more of: increasing a quantity of permanent magnets by adding one or more permanent magnets to the device body, decreasing a quantity of permanent magnets by removing one or more permanent magnets from the device body, replacing one or more permanent magnets accommodated by the device body, and/or adjusting a positioning of one or more permanent magnets accommodated by the device body in relation to the abrasive layer to achieve a target magnetic field and corresponding magnetic force, such as previously described with reference to the example configurations of FIG. 5. Alternatively or additionally, as part of setting the magnetic force of the magnetic system, the method at 1220 may include varying an electrical current supplied to the one or more electromagnets of the magnetic system to generate a magnetic field having a target strength via the one or more electromagnets, such as previously described with reference to FIG. 6.

At 1222, the method includes placing the scraper blade and guide face (including any surface-interfacing layers thereof) in contact with the surface to be cleaned. For example, the scraper blade may be loaded into the scraper blade mount and locked at a fixed orientation relative to the device body prior to or after placement of the guide face in contact with the surface at 1222. A suitable surface-interfacing layer (e.g., including an outward-facing abrasive or reduced-friction surface) may be installed on the guide face prior to placement at 1222. Alternatively, a device body including a guide face having a suitable abrasive or reduced-friction surface integrated therewith may be selected at 1214 prior to placement at 1222. At 1224, the magnetic field generated by the magnetic system urges the scraper blade and guide face against the surface of the ferromagnetic object with a magnetic force corresponding to a strength of the magnetic field.

At 1226, the method includes moving the device body relative to the surface while scraper blade and guide face (including its surface-interfacing layer thereof) is in contact with and being urged against the surface of the ferromagnetic object by the magnetic field generated by the magnetic system. Movement of the device body may include translation, rotation, and/or vibration of the abrasive layer relative to the surface. Within the context of cleaning system 100, device body 110 may be moved by hand or via a machine relative to the surface. Cleaning solutions and solvents may be applied to the surface prior to or during cleaning of the surface to aid in the removal of tape, tape residue, resin, and other contaminants. In at least some examples, setting of the magnetic force of the magnetic system previously described at 1216 may be performed while the while the device body is being moved relative to the surface.

FIG. 13 depicts an example surface-interfacing layer in the form of an abrasive layer 1300 that is permeable by ferromagnetic particulate or other contaminant particulate produced by cleaning surface 104 of example ferromagnetic object 102. Abrasive layer 1300 is a non-limiting example of surface-interfacing layer 810 of FIG. 8A. In this example, ferromagnetic particulate and contaminant particulate 1310 cleaned from surface 104 by abrasive layer 1300 permeate the abrasive layer material and move toward device body 110. Indeed, magnetic field 132 generated by magnetic system 130 may attract and capture ferromagnetic particulate during a cleaning operation. In at least some examples, abrasive layer 1300 may take the form of a porous matrix material. As non-limiting examples, abrasive layer 1300 may take the form of a flexible, woven or non-woven, fiber matrix formed of silicon carbide, aluminum oxide, talc abrasive mineral, polymer (e.g., nylon, polypropylene, etc.), or other suitable material.

FIG. 14 depicts another example abrasive layer 1400 that is permeable by ferromagnetic particulate or contaminant particulate produced by cleaning a surface of a ferromagnetic object. In this example, ferromagnetic particulate and contaminant particulate 1410 cleaned from the surface by abrasive layer 1400 permeate openings 1412 formed within the abrasive layer material. The use of openings 1412 within the abrasive layer material may enable particulate to pass through the abrasive layer while using materials that are non-porous, such as sandpaper, as an example.

Examples of the subject matter of the present disclosure are described in the following enumerated paragraphs.

A1. A cleaning system for cleaning a surface of a ferromagnetic object, the cleaning system comprising: a device body having a guide face configured for selective placement against the surface, the device body comprising a magnetic system generating a magnetic field configured to urge the guide face against the surface of the ferromagnetic object by a magnetic force; and a scraper blade projecting outward from the device body to contact the surface upon placement of the guide face against the surface.

A2. The cleaning system of paragraph A1, wherein the scraper blade projects outward from the device body at an orientation that is configured to contact the surface at an angle that is inclined relative to a surface normal.

A.3 The cleaning system of any of paragraphs A1-A2, wherein the scraper blade projects outward from the device body at an angle that is inclined relative to the guide face.

A4. The cleaning system of paragraph A3, wherein the angle is between 20 degrees and 50 degrees.

A5. The cleaning system of any of paragraphs A3-A4, wherein the scraper blade is fixed to the device body via a scraper blade mount configured to retain the scraper blade at the angle relative to the guide face and allow a distance that the scraper blade projects outward from the device body to be selectively adjusted.

A6. The cleaning system of any of paragraphs A3-A4, wherein the device body is elongate along a long axis that is parallel to the guide face; and wherein a leading edge of the scraper blade is disposed at a non-orthogonal angle relative to the long axis.

A7. The cleaning system of any of paragraphs A1-A6, wherein the guide face further comprises: a surface-interfacing layer that includes an outward-facing surface configured to contact the surface of the ferromagnetic object, the outward-facing surface having a lower coefficient of friction as compared to the guide face.

A8. The cleaning system of any of paragraphs A1-A7, wherein the guide face comprises a plurality of protrusions configured to contact the surface of the ferromagnetic object.

A9. The cleaning system of any of paragraphs A1-A6 and A8, wherein the guide face further comprises: a surface-interfacing layer that includes an outward-facing abrasive surface configured to contact the surface of the ferromagnetic object.

A10. The cleaning system of any of paragraphs A1-A9, wherein the device body has a control surface on an opposite side of the device body from the guide face, the control surface adapted to receive a palm of a human hand.

A11. The cleaning system of any of paragraphs A1-A10, wherein the device body includes a handle.

A12. The cleaning system of any of paragraphs A1-A11, wherein the magnetic system includes one or more permanent magnets.

A13. The cleaning system of paragraph A12, wherein the magnetic field generated by the magnetic system is adjustable to vary the magnetic force urging the guide face against the surface by one or more of: varying a position of the one or more permanent magnets relative to the guide face, and adding or removing the one or more permanent magnets to or from the device body.

A14. The cleaning system of any of paragraphs A1-A13, wherein the magnetic system includes one or more electromagnets; and wherein the magnetic system includes an on-board power supply or an electrical interface to an off-board power supply.

A15. The cleaning system of paragraph A14, wherein the magnetic field generated by the magnetic system is adjustable to vary the magnetic force urging the guide face against the surface by varying an electrical current supplied to the one or more electromagnets by the on-board or off-board power supply.

A16. The cleaning system of any of paragraphs A1-A15, wherein the magnetic system of the device body is a first magnetic system; and wherein a scraper blade mount configured to retain the scraper blade includes a second magnetic system, the second magnetic system generating a second magnetic field configured to urge the scraper blade against the surface of the ferromagnetic object by a second magnetic force.

A17. The cleaning system of any of paragraphs A1-A16, wherein the scraper blade projects outward from the device body at a leading edge of the guide face.

A18. The cleaning system of any of paragraphs A1-A16, wherein the scraper blade projects outward from the device body at an intermediate region of the guide face.

B1. A cleaning system for cleaning a surface of a ferromagnetic object, the cleaning system comprising: a device body having a guide face configured for selective placement against the surface, the device body comprising a magnetic system generating a magnetic field configured to urge the guide face against the surface of the ferromagnetic object by a magnetic force; and a scraper blade mount fixed to the device body to retain a scraper blade at a fixed orientation that projects outward from the device body towards the surface upon placement of the guide face against the surface.

C1. A cleaning system for cleaning a surface of a ferromagnetic object, the cleaning system comprising: a device body having an abrasive guide face configured for selective placement against the surface, the device body comprising a magnetic system generating a magnetic field configured to urge the abrasive guide face against the surface of the ferromagnetic object by a magnetic force; and a scraper blade projecting outward from the device body at an angle that is inclined relative to the guide face to contact the surface upon placement of the abrasive guide face against the surface.

The present disclosure includes all novel and non-obvious combinations and subcombinations of the various features and techniques disclosed herein. The various features and techniques disclosed herein are not necessarily required of all examples of the present disclosure. Furthermore, the various features and techniques disclosed herein may define patentable subject matter apart from the disclosed examples, and may find utility in other implementations not expressly disclosed herein.

1. A cleaning system for cleaning a surface of a ferromagnetic object, the cleaning system comprising:
a device body having a guide face configured for selective placement against the surface, the device body comprising a magnetic system generating a magnetic field configured to urge the guide face against the surface of the ferromagnetic object by a magnetic force; and
a scraper blade projecting outward from the device body to contact the surface upon placement of the guide face against the surface.

2. The cleaning system of claim 1, wherein the scraper blade projects outward from the device body at an orientation that is configured to contact the surface at an angle that is inclined relative to a surface normal.

3. The cleaning system of claim 1, wherein the scraper blade projects outward from the device body at an angle that is inclined relative to the guide face.

4. The cleaning system of claim 3, wherein the angle is between 20 degrees and 50 degrees.

5. The cleaning system of claim 3, wherein the scraper blade is fixed to the device body via a scraper blade mount configured to retain the scraper blade at the angle relative to the guide face and allow a distance that the scraper blade projects outward from the device body to be selectively adjusted.

6. The cleaning system of claim 3, wherein the device body is elongate along a long axis that is parallel to the guide face; and
wherein a leading edge of the scraper blade is disposed at a non-orthogonal angle relative to the long axis.

7. The cleaning system of claim 1, wherein the guide face further comprises:
a surface-interfacing layer that includes an outward-facing surface configured to contact the surface of the ferromagnetic object, the outward-facing surface having a lower coefficient of friction as compared to the guide face.

8. The cleaning system of claim 1, wherein the guide face comprises a plurality of protrusions configured to contact the surface of the ferromagnetic object.

9. The cleaning system of claim 1, wherein the guide face further comprises:
a surface-interfacing layer that includes an outward-facing abrasive surface configured to contact the surface of the ferromagnetic object.

10. The cleaning system of claim 1, wherein the device body has a control surface on an opposite side of the device body from the guide face, the control surface adapted to receive a palm of a human hand.

11. The cleaning system of claim 1, wherein the device body includes a handle.

12. The cleaning system of claim 1, wherein the magnetic system includes one or more permanent magnets.

13. The cleaning system of claim 12, wherein the magnetic field generated by the magnetic system is adjustable to vary the magnetic force urging the guide face against the surface by one or more of; varying a position of the one or more permanent magnets relative to the guide face, and adding or removing the one or more permanent magnets to or from the device body.

14. The cleaning system of claim 1, wherein the magnetic system includes one or more electromagnets; and
wherein the magnetic system includes an on-board power supply or an electrical interface to an off-board power supply.

15. The cleaning system of claim 14, wherein the magnetic field generated by the magnetic system is adjustable to vary the magnetic force urging the guide face against the surface by varying an electrical current supplied to the one or more electromagnets by the on-board or off-board power supply.

16. The cleaning system of claim 1, wherein the magnetic system of the device body is a first magnetic system; and
wherein a scraper blade mount configured to retain the scraper blade includes a second magnetic system, the second magnetic system generating a second magnetic field configured to urge the scraper blade against the surface of the ferromagnetic object by a second magnetic force.

17. The cleaning system of claim 1, wherein the scraper blade projects outward from the device body at a leading edge of the guide face.

18. The cleaning system of claim 1, wherein the scraper blade projects outward from the device body at an intermediate region of the guide face.

19. A cleaning system for cleaning a surface of a ferromagnetic object, the cleaning system comprising:
a device body having a guide face configured for selective placement against the surface, the device body comprising a magnetic system generating a magnetic field configured to urge the guide face against the surface of the ferromagnetic object by a magnetic force; and
a scraper blade mount fixed to the device body to retain a scraper blade at a fixed orientation that projects outward from the device body towards the surface upon placement of the guide face against the surface.

20. A cleaning system for cleaning a surface of a ferromagnetic object, the cleaning system comprising:
a device body having an abrasive guide face configured for selective placement against the surface, the device body comprising a magnetic system generating a magnetic field configured to urge the abrasive guide face against the surface of the ferromagnetic object by a magnetic force; and
a scraper blade projecting outward from the device body at an angle that is inclined relative to the guide face to contact the surface upon placement of the abrasive guide face against the surface.
